(19) United States
(12) Patent Application Publication
(10) Pub. No.: US 2001/0044849 A1
(43) Pub. Date: Nov. 22, 2001

(54) System for providing network content to wireless devices

(76) Inventors: Awele Ndili, San Jose, CA (US); Scott Moeller, San Francisco, CA (US)

Correspondence Address: WILSON SONSINI GOODRICH & ROSATI, 650 PAGE MILL ROAD, PALO ALTO, CA, 943041050

(21) Appl. No.: 09/858,355

(22) Filed: May 15, 2001

Related U.S. Application Data
(60) Provisional application No. 60/204,502, filed on May 16, 2000.

(51) Int. Cl. G06F 15/16

(52) U.S. Cl. 709/230; 709/217

(57) ABSTRACT

A method is provided for having a content engine interact with a mobile device, the method comprising: having the content engine receive a wireless communication from the mobile device that includes a card representing a URL and an identifier of the mobile device; having the content engine signal a database management system for an identification for the card to retrieve instructions for assembling the content available on the URL for the mobile device; having the content engine access a network site located by the URL to retrieve specific network events which are identified from the instructions received from the database management system; having the content engine convert the network event into a wireless format for the mobile device; and transmitting the network event in a wireless protocol to the mobile device.

### RELATED APPLICATIONS

This application is a continuation in part of U.S. patent application Ser. No. 60/204,502, entitled System For Providing Network Content To Wireless Devices, filed May 16, 2000, which is incorporated by reference herein.

### BACKGROUND OF THE INVENTION

1. Field of the Invention

This invention relates to the field of network content delivery for wireless devices.

2. Description of the Related Art

Existing wireless devices have limited access to the Internet. To access network sites, a terminal or device must communicate with sites on the network through one of the network's protocols. Terminals such as personal computers communicate with the Internet through, for example, an HTTP protocol.

Wireless devices such as cell phones have limited bandwidth and data entry capacity. The limited bandwidth significantly reduces the number, quantity and quality, of web-sites that can be made available to the user. As a result, users of wireless mediums such as cell-phone networks often have limited choices in which web-sites they can visit, and also experience lengthy download times.

Other wireless devices such as the Palm VII have capabilities to communicate with the Internet in an HTTP protocol. However, due to bandwidth constraints, such handheld computers have limited number of web sites available for browsing.

Other wireless devices such as cell phones and Sprint PCS® devices communicate with a network using a WAP protocol with HDML/WML mark-up language content. To provide Internet type access to such devices, network sites are established in an HDML/WML format.

### SUMMARY OF INVENTION

In one embodiment, a method is provided for having a content engine interact with a mobile device, the method comprising: having the content engine receive a wireless communication from the mobile device that includes a card representing a URL and an identifier of the mobile device; having the content engine signal a database management system for an identification for the card to retrieve instructions for assembling the content available on the URL for the mobile device; having the content engine access a network site located by the URL to retrieve specific network events which are identified from the instructions received from the database management system; having the content engine convert the network event into a wireless format for the mobile device; and transmitting the network event in a wireless mark-up language to the mobile device.

In another embodiment, a method is provided for providing network events and content to a mobile device, the method comprising: having a content engine receive a card from a user of mobile device specifying a network site; retrieving instructions for the specified network site from a database management system; accessing the network site using the retrieved instructions; having the content engine access a user-database to determine if user-defined parameters exist for the network site; having the content engine combine instructions and parameters to access the network site and retrieve network events and content; having the content engine convert the network event from an IP protocol with HTML format to WML, HDML and other wireless formats with WAP or another wireless protocol; having the content engine paginate the network event or content for the mobile; and transmitting the network event or content to the mobile device.

In another embodiment, a method is provided for paginating a network event into a wireless format for a mobile device; the method comprising: a) having a mobile device specify a memory allotment; b) segmenting content retrieved from an IP site segmented according to the memory allotment; c) locating a page break line or region on the retrieved network content corresponding to the boundary of each segment; d) paginating each segment on that page break line or region to ensure that the cut-off to a next segment is made at an appropriate place; e) signaling the segment to the mobile device; and f) determining whether a next segment is the last segment for the network content, wherein if the next segment is the last segment, then the last segment is signaled to mobile device as the last segment, and if there is another segment, repeating steps b-e.

In regard to each of the above methods, it is noted that computer executable logic is also provided for performing the different methods. Media is also provided for storing computer executable logic for performing the different methods. Systems are also provided for performing the logic steps and communicating the signals according to the various methods. These and other aspects of the present invention will be evident upon review of the following detailed description of the invention.

### BRIEF DESCRIPTION OF THE FIGURES

FIG. 1 is a block diagram illustrating a system for retrieving and converting network content for a mobile device, under an embodiment of the invention.

FIG. 2 is a flow chart for a system that retrieves and converts network content for the mobile device, under an embodiment of the invention.

FIG. 3 is a flow chart for a system that accesses user-defined parameters to retrieve and convert network content for the mobile device, under an embodiment of the invention.

FIG. 4 is a flow chart for a system that paginates network content for the mobile device, under an embodiment of the invention.

FIG. 5 illustrates a database management system, under an embodiment of the invention.

FIG. 6 illustrates use of memory bins for the database management system, under an embodiment of the invention.

FIG. 7 illustrates a programming tool to build a database management system for providing instructions to a content engine such as described with FIG. 1, under an embodiment of the invention.

FIG. 8 illustrates a programmer user-interface for use with a system such as described with. FIG. 7, under an embodiment of the invention.

### DETAILED DESCRIPTION

A. Overview

Embodiments of the invention include a system that is responsive to a request from a wireless device for network content existing under an Internet protocol (IP). The system retrieves the network content, and converts the network content into a wireless mark-up language for the mobile device. Among other advantages, the system reacts to the request from the mobile device to deliver the network content “on the fly”. This is in contrast to existing systems, which may require the wireless device to access only network sites operating under the corresponding wireless mark-up language.

Another embodiment of the invention provides a database management system to store instructions for responding to requests from a mobile device. The instructions enable a content engine to retrieve a network event from a network site operating under an Internet protocol. The instructions also enable the content engine to convert the network event from a format such as HTML and a protocol such as HTTP to a WAP or other wireless protocol with WML, HDML and other wireless language content formats. The instructions are provided in response to a request from the mobile device for a particular network content or event. Since the instructions are stored, the content engine is able to access the instructions and quickly respond to the request from the mobile device.

Another advantage provided by embodiments of the invention is that mobile devices operating under a wireless mark-up language are able to access any network site using stored instructions. This enables a much greater range of sites to be available for the mobile device. In contrast, other systems require that the network sites operate under a specific wireless mark-up language in order to communicate with the mobile device. These other systems require greater programming effort and resources, and are relatively limited in number.

Still further, another embodiment of the invention provides a programming tool to enable programmers to rapidly build instruction sets for individual IP network sites. The instruction sets are stored so as to be available for mobile devices that request content from the corresponding network site. The instruction sets enable IP network content to be retrieved and converted for delivery to the mobile devices, with minimal programming or computing resources required.

B. System Architecture

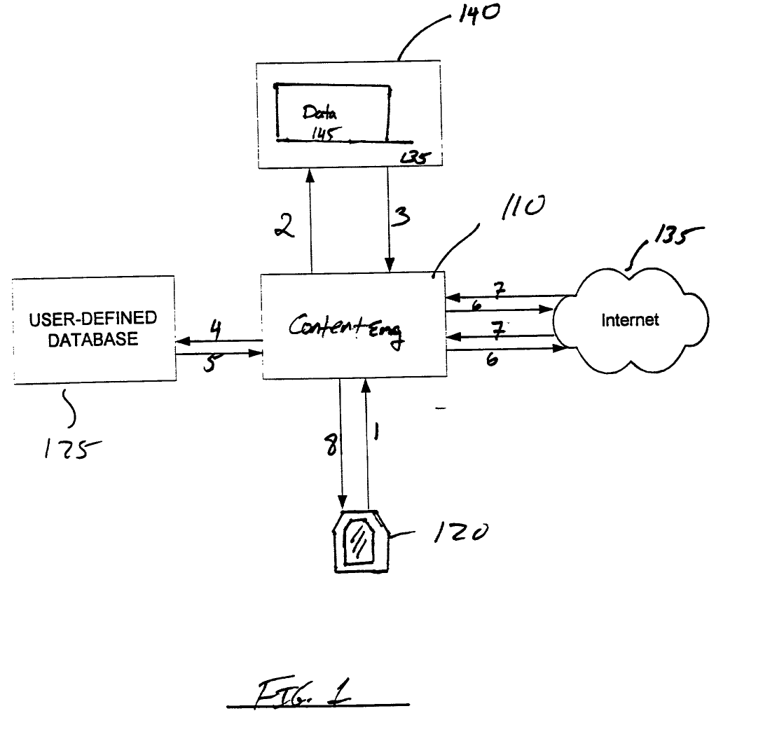

FIG. 1 is a block diagram of a system 100, under an embodiment of the invention.

The system 100 includes a database management system (DMS) 140, a content engine 110, and a wireless mobile device 120. The DMS 140 includes a database 145 and a management system 135. The content engine 110 may access to a user database 125 comprising user-defined parameters. The content engine 110 retrieves network events from a network 115 and signals the network events to mobile device 120.

The mobile device 120 includes any device that can use a wireless medium to access a network such as the Internet. Preferably, mobile device 120 is wireless access protocol (WAP) enabled. Examples of mobile devices 120 include cell-phones, PCS phones, and handheld devices. The mobile device 120 communicates with content engine 110 through the wireless medium.

The mobile device 120 may include an application for signaling network events or content to the user. For example, the mobile device 120 may include a browser to view network sites in a wireless mark-up language including for example, wireless mark-up language (WML), handheld device markup language (HDML), compact hypertext mark-up language (cHTML), mobile mark-up language (MML) and other wireless formats. A screen on the mobile device 120 may include user-interactive features and an interface to allow users to interact with a network site after viewing a network event.

As used herein, network events include content provided on a network site. Content includes all or portions of web pages available on web sites. For example, network content includes text, images, banners, media files accessible on the site, and links to other sites.

Network events also include electronic messages, as well as web-based events associated with specific sites on the Internet. Electronic messages include emails, instant messages, files existing as attachments to electronic messages, programmatic notifications of events generated by server-side modules of third parties (stock alerts), and multimedia type messages. For example, network events include emails in an HTTP or POP3 protocol. Web events may be associated with an HTML link that accesses the web event. Web events also include text or media resources appearing or linked to web pages.

In other embodiments, network events include a series of interactions with server-side modules that are accessible through links. Network interactions may include prompts from server-side modules. For example, e-commerce applications provide access to servers that receive purchasing information for a selected item. Network events also include real-time information appearing on, for example, a web page.

The DMS 140 includes a database 145 and a management system 135. The database contains instructions for content engine 110 to retrieve network events from network 135. The instructions define how the specific network event is retrieved and converted to a medium for the mobile device 120. In an embodiment, the instructions stored in database 145 specify which network sites are to be accessed in response to a request from a user, what network events are to be retrieved from the network site, and in what manner the network events are to be instructed. The instructions in database 145 may be predetermined or user-defined. The user may access a terminal to configure instructions for DMS 140.

The content engine 110 receives instructions from DMS 140 to retrieve network events available under an Internet protocol (IP), and converts the network event to a wireless mark-up language for the mobile device 120. For example, content engine 110 converts network events available under an HTTP/HTTPS protocol into a wireless markup language available under the WAP protocol.

In an embodiment, the content engine 110 may be instructed to deliver content from network sites or otherwise modify the content according to user-specified parameters stored in user database 125. The user database 125 may be configurable by users operating terminals coupleable to the Internet through an HTTP protocol. In one embodiment, each user accesses an account on user database 125 to specify one or more types of network events that need to be retrieved for mobile device 120. The users may also specify parameters on how the network events are to be converted and transmitted to mobile device 120. For example, the user may specify the frequency at which a particular network site is to be checked for selected network events. In addition, the user may specify the type of content that should be located and signaled to wireless device.

FIG. 1 illustrates communications transmitted between mobile device 120 and other components in system 100, under an embodiment of the invention. In a request 1, a user of wireless 120 specifies a card to be retrieved from network 135. The card corresponds to an IP network site, such as a web site on the Internet. The card may be a number that uniquely defines the address of the network site. The user of mobile device 120 may specify the card through an input mechanism such as a touchpad, button, or graphic user-interface. In one embodiment, the user configures mobile device 120 to display one or more use-interactive features, such as a bookmark, to enable an easy input mechanism for accessing the network site. The request 1 may also identify either the user or the device identification.

In response to receiving request 1, content engine 110 signals a request 2 to DMS 140. The request 2 locates instructions for the card specified in request 1. The DMS 140 matches the request 1 to one or more instructions in database 145.

The content engine 110 receives from DMS 140 a response 3. The response 3 includes the instructions specified by request 2. The card specified in request 1 determines the number of instructions included in communication 2. The instructions specify the network event or content to be retrieved from the network site identified by the card.

In an embodiment, once instructions in response 3 are received, content engine 110 signals to retrieve the network events from the specified card. In an embodiment, content engine 110 may signal 4 user database 125 to retrieve user-defined parameters 5 that affect, access or identify the content or event on the card specified in request 1. The content engine 110 may signal 4 user database 125 to retrieve user-defined parameters 5 before accessing the network site specified by the card.

The content engine 110 signals 6 the network 135 to access the network site specified in request 1. The network event 7 or content identified by response 3 or user-defined parameters 5 is fetched or received from the network site. The content engine 110 assembles or creates content for mobile device 120. The content engine 110 transmits a signal 7 containing the content to the mobile device 120.

In embodiments of the invention, request 1 may cause several communications to occur between content engine 110, DMS 140, user database 125, and network 135. For example, response 3 from DMS 140 may contain instructions to retrieve multiple network events or content from the network site specified by the card. The instructions in response 3 may identify network events or content available on the specified network site over a duration of time to be retrieved by content engine 110. In addition, the user database 125 may provide parameters 5 requiring several interactions between the content engine 110 and the network site specified by the card.

As a specific example, a user may specify in request 1 a card to a stock quote site on the Internet. The instructions in response 3 may cause content engine to repeatedly retrieve a stock quote from the network site. To identify the stock, the content engine 110 may access user database 125 to identify one or more stocks (parameters) previously specified by the user. The stocks are signaled 6 to the network site. The stock quote for each stock specified as a parameter in user database 125 is signaled as network event 7 each time the stock quote is retrieved from the network site. In this way, the user has to only specify a card to the network site containing stock quotes to receive repeated stock quotes. In an embodiment such as described, the user does not have to specify the stock from mobile device 120, or make separate requests for each stock quote.

Examples of network sites that can be retrieved under the example above include web sites to brokerage houses, stock pages on portals (Yahoo®, Lycos®), and streaming quote sites. The flexibility of system 100 may be shown with another example. For web sites of brokerage houses, once response 3 is received from DMS 140, content engine 110 accesses user database 125 to retrieve login, password, and other account information. The content engine 110 is then able to access the stock quote page of the user's account automatically, with no input from wireless device 110 other than request 1.

In an embodiment, communications illustrated by numerals 1-7 are carried out “on the fly”, in response to one another. The communications can simulate a real-time data exchange to the user. The rapid and robust content provided to the user in response to request 1 is in contrast to other devices which have limited accessible network sites and bandwidth.

C. Processes for Converting IP Network Events to Wireless Protocol

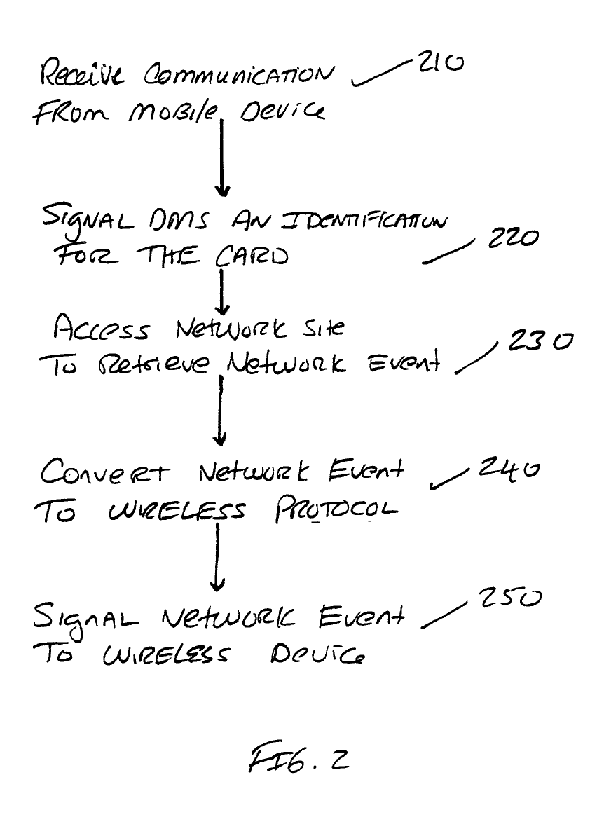

FIG. 2 illustrates a method detailing content engine 110 interacting with mobile device 120, under an embodiment of the invention. For illustration, the process is described with reference to a uniform resource locator for an e-commerce site. The process details retrieving a network event or content from an IP network such as the Internet, and then transmitting the event or content to mobile device 120.

In step 210, content engine 110 receives a communication from the mobile device 120 that includes a card corresponding to the URL, along with an identifier of the mobile device 120. The communication is transmitted through a wireless medium.

In step 220, the content engine 110 signals DMS 140 an identification for the card to retrieve instructions for assembling the content available on the URL for the mobile device 110. The content engine 110 may communicate with DMS 140 over a network such as the Internet. The instructions are for the URL of the e-commerce site. Instructions that may be provided include commands to “fetch” the URL, display the header and title for the URL, remove header tags, display a welcome message provided on the URL, and exact a pertinent section of the web page located by the URL. In an embodiment, the selected instructions are based on the identification of the card provided to the DMS 140. In another embodiment, the instructions may also be modified or otherwise configured for the URL based on the card identification.

In step 230, the content engine 110 accesses the network site located by the URL to retrieve specific network events. The network events are identified from the instructions received from DMS 140. The network events may be retrieved from the network site, or other links internal to the network site. For example, the content engine 110 may locate a home page of an e-commerce site, then select categories and locate a merchandise item for transmission to mobile device 120.

In step 240, content engine 110 converts the network event(s) into a wireless format for mobile device 120. In one embodiment, content engine 110 reformats the network event or content into a wireless format. For web sites, the event and content may be converted from an HTML format to the HDML, WML or other wireless formats. For example, HTML tags of the network event or content are programmatically converted into WML, HDML or other wireless mark-up language tags. Further details on converting HTTP or other IP protocol events into WAP, with HDML, WML or other wireless formats for WAP enabled devices are disclosed in U.S. patent application Ser. No. 60/163,115, entitled Portal Configuration in Wireless Medium, to Moeller et al., filed Nov. 2, 1999, incorporated by reference herein.

In step 250, the content or network event is transmitted in the wireless protocol to mobile device 120. The network event or content may be formatted or otherwise paginated for a display of mobile device 120.

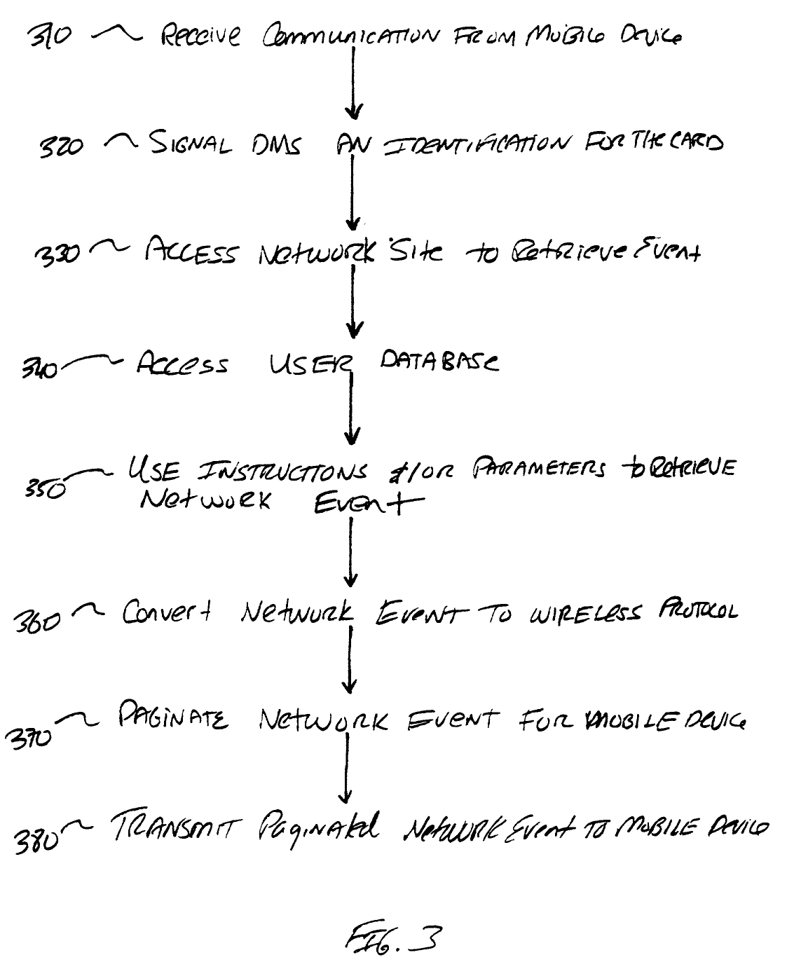

FIG. 3 illustrates another process in which user database 125 is accessed to provide network events and content to mobile device 120. In step 310, the content engine 110 receives a card from the user of mobile device 120 specifying a network site. In step 320, instructions for the specified network site are retrieved from DMS 140. In step 330, the network site is accessed In step 340, content engine 110 accesses user-database 140 to determine if user-defined parameters exist for the network site. In an embodiment, user-defined parameters are provided by the user of mobile device 120. The parameters affect content engine 110 in selecting and accessing the network event for mobile device 120. The parameters may also affect content engine 110 in configuring and/or delivering the network event to the mobile device 120. A configurable database for storing parameters for user database 125 is disclosed in U.S. patent application Ser. No. 09/513,554, entitled System and Automatic Data Retrieval on an Internet Protocol Network, to Ndili et al., filed on Feb. 25, 2000, and incorporated by reference herein.

In an embodiment, the user-defined parameters stored in user database 125 are maintained in accounts. The user of mobile device 120 may configure the account to include preferred parameters. Examples of parameters that may be specified in user database 125 include login and password information to a particular site, such as an e-mail site, or a proprietary information site. A user may also specify as a parameter the frequency in which a network event or content is retrieved once the network site is accessed by content engine 110. As another example, for an auction site, the user may specify a specific search term or auction item as a parameter.

In step 350, content engine 110 combines instructions and parameters to access the network site and retrieve network events and content. The instructions and parameters combine to control the content engine 110 in accessing the network site specified by the card signaled from the mobile device 120.

In step 360, content engine 110 converts the network event from the IP protocol with HTML format to WML, HDML or other wireless format with WAP or another wireless protocol. In step 370, content engine 110 paginates the network event or content for mobile device 120. In step 380, the network event or content is transmitted to mobile device 120.

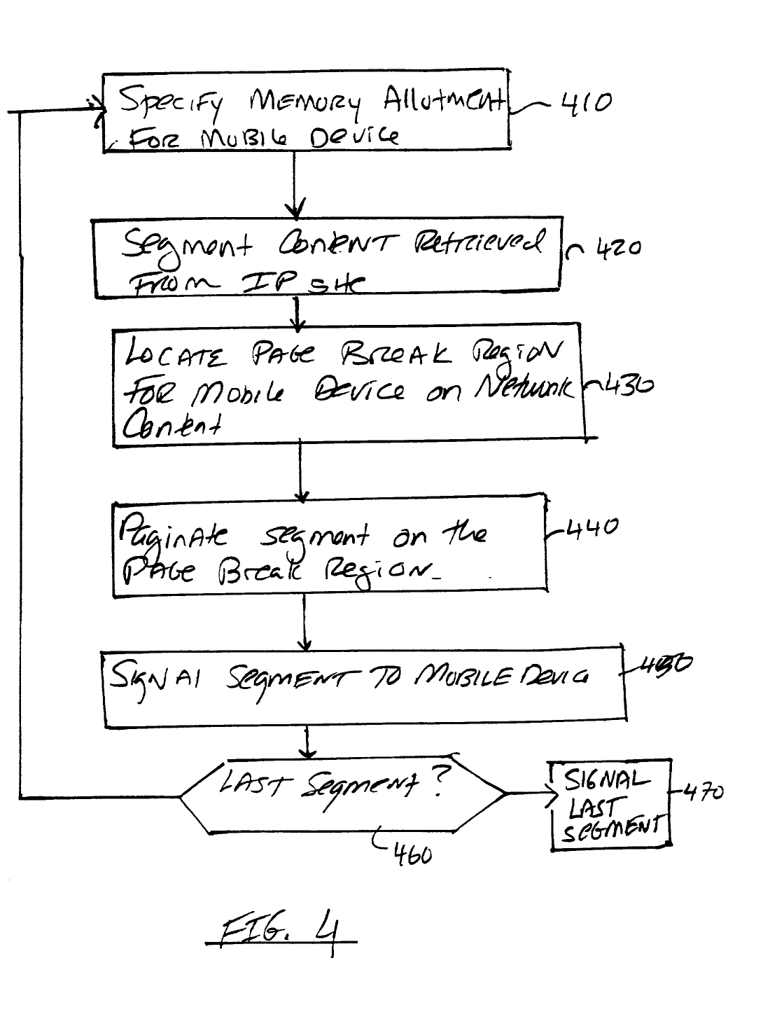

FIG. 4 illustrates a method performed by content engine 110 in paginating the network event into the wireless format. A process such as described with FIG. 4 enables events to be retrieved from IP sites and then converted for mobile devices 120. The content appearing on mobile device 120 is properly paginated for the screen of the mobile device 120, with no modification at the network site or mobile device 120. The process described with FIG. 4 assumes that content engine 110 has retrieved the network content from the network 135.

In step 410, a memory allotment is specified for mobile device 120. The memory allotment depends on the wireless protocol in use, and the desired page size which can be a function of the screen size of target mobile device 120. The memory allotment may be designated as, for example, 1 k, representing the average screen size of WAP pages for mobile phones. Alternatively, a user of mobile device 120 may configure the memory allotment depending on the specific type and model of mobile device 120 being used. In an embodiment, the memory allotment is specified through user database 125.

In step 420, the content retrieved from the IP site is segmented according to the memory allotment. Each segment is portioned to correspond approximately to the memory allotment. The size of the segments allows each segment to be displayed in its entirety as one page on mobile device 120. As an example, if a journal article on a web site is 24 k in length, the article is segmented roughly into 24 1 k segments.

In step 430, a page break line or region is located on the retrieved network content corresponding to the boundary of each segment. The content engine 110 may locate a line or region where the 1 k break occurs.

Then in step 440, each segment is paginated on that page break line or region to ensure that the cut-off to a next segment is made at an appropriate place. If a segment of network content retrieved from the IP site is not paginated, HTML coding may not correctly be converted to WML, HDML or other wireless formats. In addition, words may be split up to appear on different pages on mobile device 120.

In an embodiment, a free unattached space is located to correctly paginate each segment on the page break line or region. For HTML coding, the free unattached space is positioned outside of tags and other coding appearing on that portion of the network content. Specifically, the content engine 110 locates spacing outside of HTML open end and close end tags. As an example, the line of coding appearing on a page break line may be:

<a href=www.mobileshift.com>click here <br>to see </a>

The content engine 110 identifies spaces before “<a href”, and after “</a>” as places where a page break may occur. The content engine 110 ignores spacing falling between the opening and closing of the <a> . . . . </a> tags. In this way, the page displayed on the screen of mobile device 120 contains entire words and code signments, and is coded, for example, from HTML to WML, HDML or other wireless formats appropriately.

To ensure the free unattached space is between an open or closed bracket, the content engine 110 may include coding that measures on the page break line the distance between the first located space and an open tag “<”. The coding then measures the space between the located space and the closed tag “>”. If the distance between the located space and the open tag is less than the distance between the located space and the open tag, then the located space is considered free and unattached. The located space is then made the location of a page break.

If the distance between the located space and the open tag is greater than the distance between the located space the close tag, then the located space is considered attached. A next space is then located on the break line. The next space may correspond to the space appearing to the right of the close tag. The spaces appearing on the page break line are checked in this manner until a free unattached space is located. Once the free unattached space is located, the segment is paginated.

In step 450, the segment is signaled to mobile device 120. The segment may be signaled with a user-interactive feature (icon) to signal a request for a next segment. In step 460, a determination is made as to whether a next segment is the last segment for the network content. If in step 460, a next segment is a last segment, then the last segment is signaled to mobile device 120 in step 470 as the last segment. If there is another segment, then steps 410-460 are repeated.

D. Database Management System

Under an embodiment, DMS 140 manages a database of instructions that are selectively signaled to content engine 110 in response to content engine 110 receiving a request from mobile device 120. The instructions stored with DMS 140 each include one or more commands pertaining to retrieving and converting IP network content to a wireless format available under the WAP or other wireless protocol. The DMS 140 is configured to instruct content engine 110 to retrieve and convert IP network events responsive to inputs from mobile device 120, without requiring mobile device 120 to communicate using an IP protocol, and without requiring network 135 to provide content using a WAP protocol.

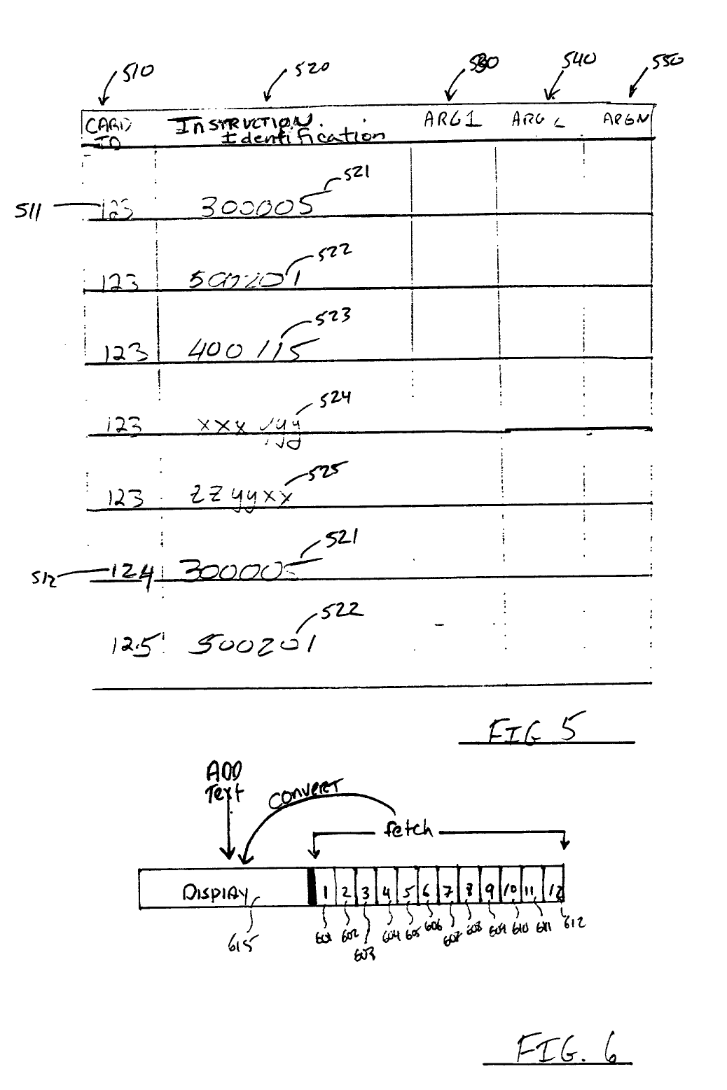

FIG. 5 illustrates a configuration of DMS 140, under an embodiment of the invention. In an embodiment, DMS 140 is organized into a spreadsheet like format. A first column 510 lists a card identification 511, 512. A second column 520 lists an instruction identification 521-525. A third column 530, fourth column 540, and nth column 550 list arguments. To make a network site accessible to content engine 110, a programmer or editor of DMS 140 lists cards in the first column 510, selects instructions for column 520, and provides arguments for the instructions in columns 530-550. In alternative embodiments, a user of mobile device 120 may access and configure DMS 140.

The instruction identifications 521-525 correspond to one or more commands that have to be performed by content engine 110. Examples of instructions that may be specified in column 520 includes:

fetch: retrieves content or event from network site, places content into a drop bin;

convert: converts network content in drop bin from IP to WAP, places converted content in a display bin;

add text: drops content inputted from user/editor on IP terminal into display bin; and

split page: paginates content for mobile device.

The instructions listed above are exemplary, and several other instructions may be readily apparent to enable IP network content to be converted to WAP content. For example, other instructions may include skip text, extract phrases, and skip end character.

The instructions include one or more commands. For example, convert may include routines to identify and remove HTML tags from a page retrieved from a web site. Then, convert includes commands to insert HDML, WML or other wireless mark-up language tags in appropriate places that correspond to the HTML tags. Certain tags on HTML pages may be identified and ignored. Other wireless mark-up language tags may be added automatically.

Preferably, the identifiers to the instructions are numeric, and are indicative of the instruction. For example, one or more numerals in the instruction identifier may represent that the instruction involves displaying content. In other embodiments, other symbols may be used to identify the instructions, such as shown by instruction identifiers 524 and 525.

The first column 510 includes cells that list each card multiple times. In an embodiment, a card occupies two or more cells in first column 510. The number of cells occupied by each card corresponds to the number of instructions each card requires.

The arguments contained in the third columns 530, fourth columns 540 and nth columns 550 are for the instructions specified in second column 520. The arguments may be provided by the programmer for each instruction provided for a card. The arguments may also be predefined for each instruction.

The arguments listed in each column 530-550 may be specific to certain instructions, or applicable to all instructions for a card. In one of the columns 530-550, the arguments specify a sequence in which the instructions are executed by content engine 110. For example, when a card is specified by mobile device 120, the arguments may specify content engine 110 to first fetch network content, then add text, and then convert the network content to WML, HDML or other wireless formats. When another card is specified by mobile device 120, content engine 110 may specify content engine 110 to first fetch the content, then convert the content to WML, HDML or other wireless formats.

In an embodiment, the argument for one of the columns 530-550 identifies the URL of the IP network site. Each card in DMS 140 includes at least one instruction specifying the URL of the card.

In an embodiment, each card includes a fetch instruction. Each fetch may include an argument to identify whether the network content or event being retrieved is secure or unsecure. Each fetch may also include an argument to identify whether the command is a “get” for retrieving content from the IP site, or a “push” to provide information to the IP network site before retrieving events. Each argument for fetch occupies one of the columns 530-550. One or more of the arguments for fetch may be applicable to other instructions.

Another argument specifies whether user-defined parameters exist for the card. The card may include an additional fetch to retrieve the parameters in the user database 125. The identification of mobile device 120 may specify the applicable account in user database 125 for the user of mobile device 120. In an embodiment, fetch to retrieve the user-defined parameters is specified by arguments to be executed before fetch to retrieve network content from the IP site. Once the parameters are retrieved from user database 125, the fetch to retrieve the network content from the IP site includes the user-defined parameters. For example, the parameters may be contained as a tail portion of the URL to the IP network site.

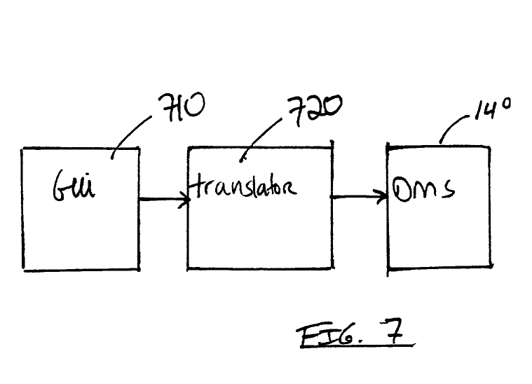

Another example of an argument specified for one or more instructions, including fetch, is a specific memory bin for the instruction to use. Additional details on memory bins are provided with FIG. 6.

FIG. 6 illustrates memory bins used to retrieve network content and convert the network content from an IP protocol to the wireless protocol. The memory bins are used by the instructions to retrieve network content and convert network content to the wireless protocol. An embodiment such as shown by FIG. 6 includes a display bin 615, and a plurality of drop bins 601-612. For illustration, operation of basic instructions fetch, convert, and add text are shown in combination with drop bins 601-612 and display bin 615 to convert data retrieved from IP network sites to a protocol for mobile device 120. Other instructions may be used, depending on the card.

When content engine 110 executes fetch, one of the arguments specify a drop bin 601-612 where the network content or event is deposited. One of the drop bins 601-612 may be designated as a default. Multiple drop bins 601-612 may be used when a card requires fetch to be executed multiple times on one or more network sites.

When content engine 110 executes convert, the network content from bins 601-612 is converted to the wireless mark-up language and deposited in display bin 615. When content engine 110 executes add text, content for mobile device 120 is added to display bin 615. When all instructions are completed, the content of the display bin 615 is signaled to mobile device 120. The content may then be signaled to the mobile device 120 in a wireless protocol.

As illustrated with FIGS. 5 and 6, DMS 140 enables content engine 110 to use stored instructions for near real-time conversion, construction, and delivery of WAP content to mobile device 120. The stored instructions minimize computation resources required from content engine 110, so as to enable content engine 110 to provide WAP content as an immediate response from a user of mobile device 120.

In one example, DMS 140 includes instructions for a brokerage site. The brokerage site is requested by the user of mobile device 120. The request is identified as a card 511, 512 in column 510 of FIG. 5. The card includes arguments identifying the URL of the brokerage site in column 530-550. The instructions include a first fetch to retrieve password and login information from user-database 125. The first fetch is signaled with identification to identify the user account, signaled with the request from mobile device 120. The first fetch includes arguments to retrieve information from the user-database 125. A second fetch pushes the password and log-in information to the brokerage account as parameters to the URL for that network site. A third fetch retrieves account information from the network site. The account information is dropped in drop bin 601. The card may subsequently specify a convert instruction to convert the information in memory bin 601, and to deposit the converted information into display bin 615. The contents of display bin 615 are then signaled to mobile device 120.

In another example, DMS 140 includes instructions for comparison shopping. Multiple cards may be signaled from mobile device 120 to identify multiple network shopping sites. Alternatively, one site may be specified in the card which then automatically identifies other shopping sites. The content retrieved from the multiple sites are individually deposited in respective drop bins 601-612. Another instruction to compare the contents of the memory bins 601-612 may be executed. The comparative result may be placed in a WML, HDML or other wireless format and placed in display bin 615. The contents of display bin 615 are then signaled to mobile device 120.

E. Programmer Interface for Developing DMS

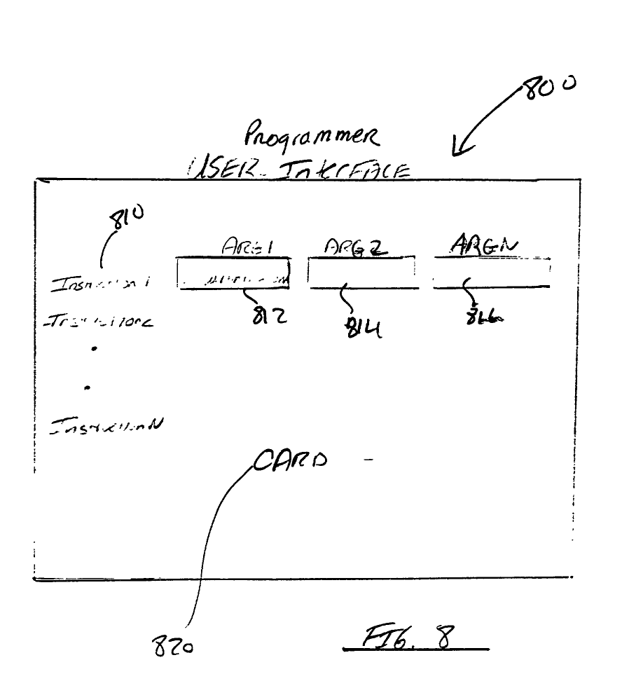

FIG. 7 illustrates a system for enabling a programmer to develop instructions for a management system such as described with DMS 140. The system includes a graphic user-interface (GUI) 710, a translator 720, and DMS 140. The DMS 140 may be part of a system such as described with FIG. 1.

In an embodiment, the GUI 710 displays objects to enable a programmer to select instructions. The instructions may appear as part of a display, or as user-interactive features such as icons. The GUI 710 also displays features and objects to enable the programmer to select arguments for the instructions. In addition, the GUI 710 may include other features, such as text fields to enable the programmer to add text for delivery to mobile device 120.

The translator 720 converts the selected objects and other input from the programmer for DMS 140. In an embodiment, translator 720 converts selected instructions into the numerical format shown in FIG. 5. Preferably, translator 720 identifies each input from the programmer and locates a position for the input in the chart shown by FIG. 5.

FIG. 8 illustrates an exemplary user-interface 800 for use with an embodiment of the invention. The user-interface 800 lists instructions 810 available for DMS 140 in one portion. The programmer may select instructions using icons or other user-interactive selection feature. The user-interface 800 may also display argument fields 812, 814, and 816. The argument fields may be in the form of text fields, where the programmer enters argument data for DMS 140. An identifier 820 identifies the card for which the instruction set is being built. The identifier 820 may be a programmer-input, or be automatically generated when the programmer specifies a target URL for the set of instructions.

As an example, the programmer may specify multiple instructions, including fetch and convert, from one of the listed instructions 810. The programmer then identifies the URL as one of the arguments 812-816. The programmer may also use another of the arguments 812-816 to specify whether the card or the instruction is secure or unsecured. Similarly, the programmer may use another one of the arguments 812-816 to specify whether the information is pushed or retrieved from the network site. Other arguments may be added in a similar fashion.

An advantage provided with system 700 and user-interface 800 is that programmers may simplify the process of storing instructions in DMS 140. The simplified process enables content engine 110 to retrieve network events and contents from many sites. Further, the simplified approach prevents against excessive programming that may otherwise hinder content engine 110 from being able to quickly respond to network requests from mobile device 120.

F. Conclusion

The foregoing description of various embodiments of the invention has been presented for purposes of illustration and description. It is not intended to limit the invention to the precise forms disclosed. Many modifications and equivalent arrangements will be apparent.

1. A method for having a content engine interact with a mobile device, the method comprising:
having the content engine receive a wireless communication from the mobile device that includes a card representing a URL and an identifier of the mobile device;
having the content engine signal a database management system for an identification for the card to retrieve instructions for assembling the content available on the URL for the mobile device;
having the content engine access a network site located by the URL to retrieve specific network events which are identified from the instructions received from the database management system;
having the content engine convert the network event into a wireless format for the mobile device; and
transmitting the network event in a wireless protocol to the mobile device.

2. A method according to claim 1 wherein the content engine signals the database management system over a network.

3. A method according to claim 1 wherein the selected instructions are based on the identification of the card provided to the database management system.

4. A method according to claim 1 wherein the instructions are configured for the URL based on the card identification.

5. A method according to claim 1 wherein the content engine reformats the network event or content into a wireless format.

6. A method according to claim 1 wherein the network event or content is formatted for a display of the mobile device.

7. A method for providing network events and content to a mobile device, the method comprising:
having a content engine receive a card from a user of mobile device specifying a network site;
retrieving instructions for the specified network site from a database management system;
accessing the network site using the retrieved instructions;
having the content engine access a user-database to determine if user-defined parameters exist for the network site;
having the content engine combine instructions and parameters to access the network site and retrieve network events and content;
having the content engine convert the network event from an IP protocol to a wireless protocol;
having the content engine paginate the network event or content for the mobile device; and
transmitting the network event or content to the mobile device.

8. A method according to claim 7 wherein the user-defined parameters are provided by a user of the mobile device.

9. A method according to claim 7 wherein the user-defined parameters affect how the content engine selects and accesses the network event for the mobile device.

10. A method according to claim 7 wherein the user-defined parameters affect how the content engine delivers the network event to the mobile device.

11. A method according to claim 7 wherein the user-defined parameters are stored in a user database and maintained in accounts.

12. A method according to claim 11 wherein the accounts are configurable to include preferred parameters.

13. A method for paginating a network event into a wireless format for a mobile device; the method comprising:
a) having a mobile device specify a memory allotment;
b) segmenting content retrieved from an IP site segmented according to the memory allotment;
c) locating a page break line or region on the retrieved network content corresponding to the boundary of each segment;
d) paginating each segment on that page break line or region to ensure that the cutoff to a next segment is made at an appropriate place;
e) signaling the segment to the mobile device; and
f) determining whether a next segment is the last segment for the network content, wherein if the next segment is the last segment, then the last segment is signaled to the mobile device as the last segment, and if there is another segment, repeating steps b-e.

14. A method according to claim 13 wherein the memory allotment is configurable depending on the type of the mobile device.

15. A method according to claim 13 wherein the memory allotment is specified through a user database.

16. A method according to claim 13 wherein a free unattached space is located to correctly paginate each segment on the page break line or region.
